(19) United States
(12) Patent Application Publication
(10) Pub. No.: US 2009/0323500 A1
(43) Pub. Date: Dec. 31, 2009

(54) OPTICAL HOLOGRAPHIC DEVICE AND METHOD WITH ALINGNMENT MEANS

(75) Inventors: Frank Jeroen Pieter Schuurmans, Eindhoven (NL); Floris Maria Hermansz Crompvoets, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/441,580

(22) PCT Filed: Sep. 17, 2007
(86) PCT No.: PCT/IB07/53746

§ 371 Date: Mar. 17, 2009

(30) Foreign Application Priority Data
Sep. 21, 2006 (EP) 06121007.6

(51) Int. Cl. G11B 7/00

(52) U.S. Cl. 369/103; G9B/7

(57) ABSTRACT

The present invention relates to an optical holographic device and a corresponding method for reading out a data page recorded in a holographic recording medium (106) and carrying data modulated using a block modulation code, according to which a data page is divided into a number of blocks and a code constraint is applied defining the number of data symbols in a block having a predetermined symbol value. In order to avoid for storing any alignment marks for determining the alignment of the blocks of the block modulation code, a device is proposed having alignment means (115) for determining the alignment of the blocks in a detected imaged data page by iteratively determining, for a different alignment of the blocks in each iteration, whether for said alignments said code constraint is fulfilled or not, and decoding means (116) for decoding the block modulated data from said detected imaged data page based on the determined alignment of the blocks.

### FIELD OF THE INVENTION

The present invention relates to an optical holographic device and a corresponding method for reading out a data page recorded in a holographic recording medium and carrying data modulated using a block modulation code, according to which a data page is divided into a number of blocks and a code constraint is applied defining the number of data symbols in a block having a predetermined symbol value. Further, the present invention relates to an electronic device and a corresponding method for use in such an optical holographic device. Finally, the present invention relates to a computer program for implementing said methods in software.

### BACKGROUND OF THE INVENTION

Holographic Data Storage Systems (HDSS) promise high data capacities (1 TByte on a 12-cm disc) and high data rates (Gbit/s). The advantage of holographic data storage over conventional optical storage is that it uses the real 3D volume of the medium to store the data making high capacities possible. An overview of Holographic Data Storage Systems is given in “Holographic Data Storage Systems”, Lambertus Hesselink, Sergei S. Orlov, and Matthew C. Bashaw, Proceedings of the IEEE, vol. 92, no. 8, pp. 1231-1280, 2004.

In holographic data storage often the data is encoded using a (balanced) block modulation code, which is also described in the above mentioned reference, in order to yield a low user bit error rate. A common balanced block modulation code is the so-called 6:8 code, in which the data page is divided into subarrays (also called blocks) of 2*4 (=8) pixels and each of these subarrays contains exactly 4 zeros and 4 ones (hence the balanced code). Since for each subarray 70 (=8 choose 4) different configurations are possible, 6 bits can be encoded per subarray, as 2⁶=64<70 and leaving 6 redundant configurations. Clearly the code rate is 6:8=0.75, as 6 user bits are encoded using 8 pixels. This encoding is powerful, as once the position of each block is known, a simple sorting algorithm suffices to determine the four 0s and four 1s.

Typically, to determine the position of each subarray, fiducials, i.e. alignment marks, are incorporated into the data page, as e.g. described in U.S. Pat. No. 5,838,650. The alignment marks are detected and the holographic medium is translated and rotated until the right alignment marks are retrieved on the detector. However, such a detection method is not suitable for a high-density holographic medium, because the alignment marks require space in the holographic medium, which reduces the possible data density/rate.

### SUMMARY OF THE INVENTION

It is an object of the present invention to provide an optical holographic device and a corresponding method for reading out a data page recorded in a holographic recording medium, which do not require any alignment marks for determining the alignment of the blocks of a block modulation code. It is a further object to provide an electronic device and a corresponding method for use in such an optical holographic device and to provide a computer program for implementing said methods.

The object is achieved according to the present invention by an optical holographic device as defined in claim 1, said device comprising:

image forming means for forming an imaged data page,

image detection means for detecting said imaged data page,

alignment means for determining the alignment of the blocks in said detected imaged data page by iteratively determining, for a different alignment of the blocks in each iteration, whether for said alignments said code constraint is fulfilled or not, and

decoding means for decoding the block modulated data from said detected imaged data page based on the determined alignment of the blocks.

The object is further achieved according to the present invention by an electronic device as defined in claim 8, said electronic device comprising:

alignment means for determining the alignment of the blocks in said detected imaged data page by iteratively determining, for a different alignment of the blocks in each iteration, whether for said alignments said code constraint is fulfilled or not, and

decoding means for decoding the block modulated data from said detected imaged data page based on the determined alignment of the blocks.

The object is still further achieved according to the present invention by a computer program comprising program code means for causing a computer to carry out the steps of the method as claimed in claim 9 or 10, when said computer program is carried out on a computer.

Corresponding methods are defined in further independent claims. Preferred embodiments of the invention are defined in the dependent claims. It shall be understood that the electronic device, the methods and the computer program have similar and/or identical preferred embodiments as defined in the dependent claims.

The present invention is based on the idea to iteratively check for different alignments whether a given code constraint of the block modulation code is fulfilled or not. For instance, in the above explained example of a balanced block 6:8 code, a code constraint is that each block exactly contains four 0s and four 1s. This is then, at a given iteration and a given alignment, checked for at least one, but preferably a number of blocks, which can be done in different ways. If the correct alignment will be found in an iteration, the iterative search is stopped and based on the found alignment the detected imaged data page is decoded.

The present invention can generally be applied, according to preferred embodiments, to both a balanced modulation code and an unbalanced modulation code. The detection of the ideal alignment is generally more accurate and easier. An unbalanced code is less efficient, i.e. less user bits can be stored in a given number of channel bits. For instance, with 3 “1” pixels and 5 “0” pixels there are 56 unique possibilities which is less than the 70 possibilities in case of using a balanced code. This means that only 5-bits “words” can be encoded using an unbalanced code instead of 6-bits words a balanced code. The code efficiency of such an unbalanced code thus would be 5:8=0.625 which is less than the code efficiency of 6:8=0.75 for the balanced code. However, for both codes it is generally required that the numbers of data symbols in a block having a first symbol value and having a second symbol value are identical for all blocks and known to the alignment means.

According to a further preferred embodiment the alignment means are adapted for determining, in each iteration, a significance value or function based on the symbol values per block and based on a number of blocks of said determined imaged data page and for determining, whether, for the alignment of the blocks applied in said iteration, said code constraint is fulfilled or not based on said significance value or function. Said significance value or function can generally be any value or function that allows to distinguish between aligned blocks and non-aligned blocks. Preferably, said value or function is selected such that they show large differences for aligned and non-aligned blocks, but that their determination requires only a small overhead in terms of calculation power and storage space.

Advantageous embodiments for preferred significance values or functions are given in further dependent claims. For instance, the sum of the symbol values and/or the summed intensity values for said number of blocks are used as said significance value according to one embodiment, while according to another embodiment a probability function indicating the probability to find a summed symbol or intensity value in a block is used as said significance function. In particular, the width of said probability function is determined and used for checking whether said width is smaller than a predetermined width.

### BRIEF DESCRIPTION OF THE DRAWINGS he invention will now be explained in more detail with reference to the drawings in which

FIG. 1 shows an optical holographic device according to the present invention,

FIG. 2 shows the eight different alignment configurations for 2*4 sub-arrays of a 6:8 balanced block modulation code,

FIG. 3 shows the probability function for configurations 2-5 shown in FIG. 2, and

FIG. 4 shows a flow-chart illustrating the present invention.

### DETAILED DESCRIPTION OF EMBODIMENTS

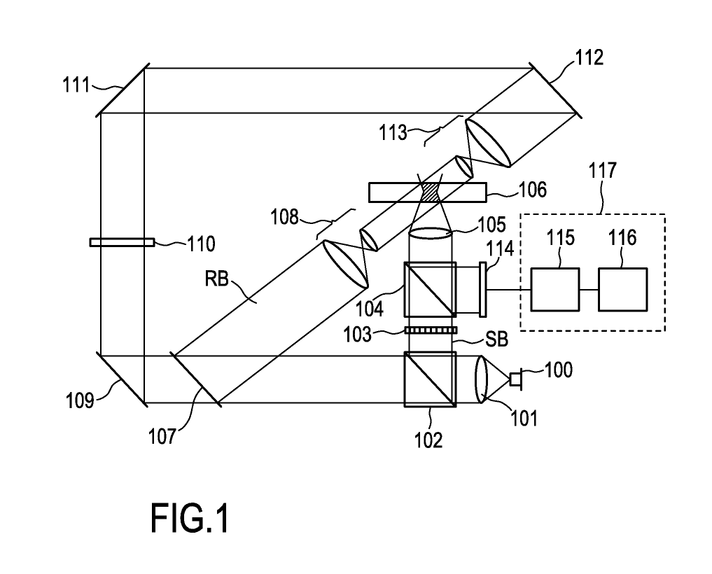

FIG. 1 shows an optical holographic device according to the present invention using phase conjugate read out. This optical device comprises a radiation source 100, a collimator 101, a first beam splitter 102, a spatial light modulator 103, a second beam splitter 104, a lens 105, a first deflector 107, a first telescope 108, a first mirror 109, a half wave plate 110, a second mirror 111, a second deflector 112, a second telescope 113, a detector 114, an alignment unit 115 and a decoding unit 116. The optical device is intended to record in and read data from a holographic medium 106.

The alignment unit 115 and the decoding unit 116 preferably form an electronic device 117, such as a dedicated integrated circuit or other hardware, that is separately distributed and that can, for instance, be added to existing holographic optical devices. Alternatively, the functions of the alignment unit 115 and the decoding unit 116 can also be implemented in software running, e.g., on a computer or a microprocessor.

During recording of a data page in the holographic medium 106, half of the radiation beam generated by the radiation source 100 is sent towards the spatial light modulator 103 by means of the first beam splitter 102. This portion of the radiation beam is called the signal beam SB. Half of the radiation beam generated by the radiation source 100 is deflected towards the telescope 108 by means of the first deflector 107. This portion of the radiation beam is called the reference beam RB. The signal beam SB is spatially modulated by means of the spatial light modulator 103. The spatial light modulator 103 comprises transmissive areas and absorbent areas, which corresponds to zero and one data-bits of a data page to be recorded. After the signal beam has passed through the spatial light modulator 103, it carries the signal to be recorded in the holographic medium 106, i. e. the data page to be recorded. The signal beam is then focused on the holographic medium 106 by means of the lens 105.

The reference beam RB is also focused on the holographic medium 106 by means of the first telescope 108. The data page is thus recorded in the holographic medium 106, in the form of an interference pattern as a result of interference between the signal beam SB and the reference beam RB. Once a data page has been recorded in the holographic medium 106, another data page is recorded at a same location of the holographic medium 106. To this end, data corresponding to this data page are sent to the spatial light modulator 103. The first deflector 107 is rotated so that the angle of the reference signal with respect to the holographic medium 106 is modified. The first telescope 108 is used to keep the reference beam RB at the same position while rotating. An interference pattern is thus recorded with a different pattern at a same location of the holographic medium 106. This is called angle multiplexing. A same location of the holographic medium 106 where a plurality of data pages is recorded is called a book.

Alternatively, the wavelength of the radiation beam may be tuned in order to record different data pages in a same book. This is called wavelength multiplexing. Other kinds of multiplexing, such as shift multiplexing, may also be used for recording data pages in the holographic medium 106. Such multiplexing techniques are also described in the above-cited document “Holographic Data Storage Systems”.

During readout of a data page from the holographic medium 106, the spatial light modulator 103 is made completely absorbent, so that no portion of the beam can pass trough the spatial light modulator 103. The first deflector 107 is removed, such that the portion of the beam generated by the radiation source 100 that passes through the beam splitter 102 reaches the second deflector 112 via the first mirror 109, the half wave plate 110 and the second mirror 111. If angle multiplexing has been used for recording the data pages in the holographic medium 106, and a given data page is to be read out, the second deflector 112 is arranged in such a way that its angle with respect to the holographic medium 106 is the same as the angle that were used for recording this given hologram. The signal that is deflected by the second deflector 112 and focused in the holographic medium 106 by means of the second telescope 113 is thus the phase conjugate of the reference signal that were used for recording this given hologram. If for instance wavelength multiplexing has been used for recording the data pages in the holographic medium 106, and a given data page is to be read out, the same wavelength is used for reading this given data page.

The phase conjugate of the reference signal is then diffracted by the information pattern, which creates a reconstructed signal beam, which then reaches the detector 114 via the lens 105 and the second beam splitter 104. An imaged data page is thus created on the detector 114, and detected by said detector 114. The detector 114 comprises pixels. While in one embodiment each pixel corresponds to a bit of the imaged data page, in another embodiment (which is preferred here) the detector 114 has more pixels than the imaged data page, i.e. the image is oversampled by the detector 114. In any case, the imaged data page should be carefully aligned with the detector 114, in such a way that one bit or a given number of bits of the imaged data page impinges on the corresponding pixel of the detector 114.

Now, there are many degrees of freedom in the system, so that the imaged data page is not always carefully aligned with the detector 114. For example, a displacement of the holographic medium 106 with respect to the detector 114, in a direction perpendicular to the axis of the reconstructed signal beam, leads to a translational misalignment. A rotation of the holographic medium 106 or the detector 114 leads to an angular error between the imaged data page and the detector 114. A displacement of the holographic medium 106 with respect to the detector 114, in a direction parallel to the axis of the reconstructed signal beam, leads to a magnification error, which means that the size of a bit (or a give number of bits) of the imaged data page is different from the size of a pixel of the detector 114.

Further, as explained above, spatial light intensity fluctuations in the laser beams during writing of the data, as well as during read-out, lead to unwanted variations in the acquired image upon read-out. Still further, the non-uniform pixel response of the image detector 114 adds to these unwanted variations. In addition, the holographic medium 106 might scatter the laser light inhomogeneously, making the intensity fluctuations in the image even more severe. These variations make correct bit detection difficult.

Often, as explained above, the data is encoded using a balanced or unbalanced block modulation code to achieve a low user bit error rate. In a balanced block modulation code (e.g. a 6:8 code) the data page is divided into subarrays of a predetermined number (e.g. 2*4=8) of pixels, and each of these subarrays contains a predetermined number of zeros and ones (for subarrays of 8 pixels contains exactly 4 zeros and 4 ones). In an unbalanced block modulation code the data page is also divided into subarrays of a predetermined number of pixels, but the predetermined number of zeros is different from the predetermined number of ones. These numbers are, however, equal for all subarrays. To illustrate the invention, in the following a balanced 6:8 block modulation code shall be considered.

Instead of using fiducials or alignment marks, which are typically incorporated into the data page to determine the position of each subarray, according to a preferred embodiment of the present invention it is proposed to use the variation/distribution of the summed intensity for each block to determine the alignment of the blocks. As, in the case of perfect alignment, the summed intensity of each block will always be 4 (for the exemplary 6:8 code having in each block four ones and four zeros) and thus the variation will ideally be zero. For any other, misaligned situated, pixels from at least two different blocks contribute to the summed intensity and the code constraint of four zeros and four ones is absent, resulting in considerable variation over the data page of this summed intensity.

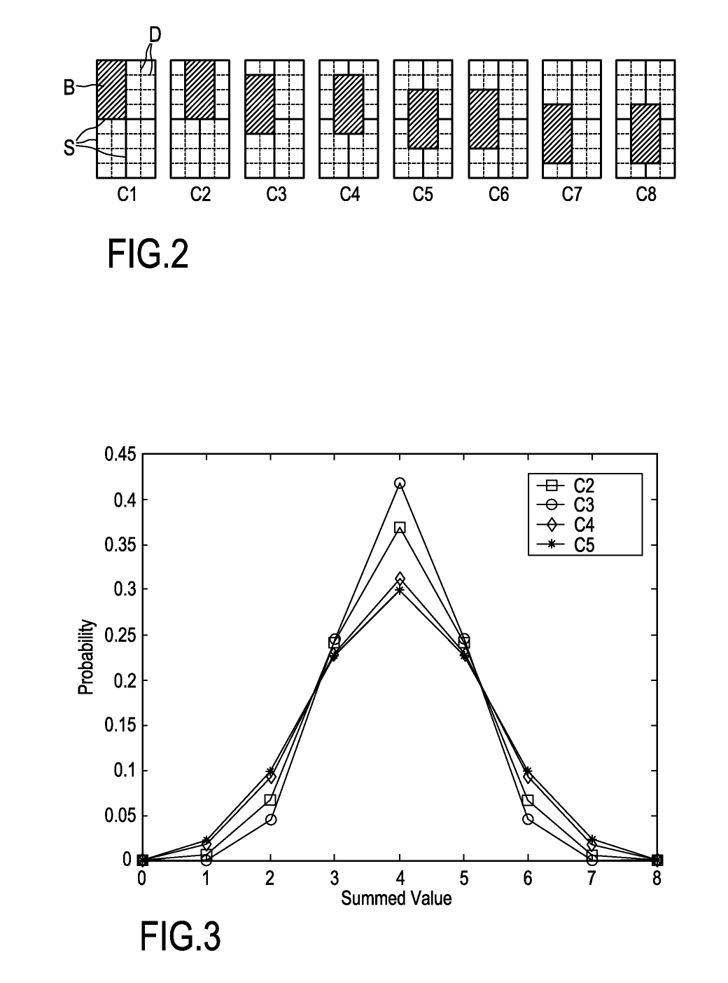

FIG. 2 shows the eight different alignment configurations C1 to C8 for subarrays of 2*4 pixels of the this exemplary code, of which only the first configuration C1 is aligned. The solid lines S indicate the boundary of the 2*4 subarrays, the dashed lines D indicated the individual pixels, and the filled blocks B are the 2*4 domains (only one shown per configuration) indicating the assumed alignment of the subarrays in said configuration. To determine whether the alignment of assumed according to a certain configuration is correct or not, the intensities of a number of said 2*4 domains are summed and evaluated as explained in the following.

As mentioned already, for misaligned situations the summed intensity will show a considerable variation over the data page. In order to determine the magnitude of this variation, the distribution functions for all possible eight different alignment configurations C1 to C8 shown in FIG. 2 has been calculated. From symmetry it is easy to show that configuration C6 is similar to configuration C2, configuration C7 is similar to configuration C3, and configuration C8 is similar to configuration C4, yielding identical statistics for each pair and allowing only to consider configurations C1 to C5. For each of the configurations C2 to C5, the probability to find a summed intensity value between 0 and 8 has been calculated and depicted in a diagram shown in FIG. 3. Obviously, configuration C1 yields a probability of 1 for a summed value of 4, and 0 otherwise; this probability for configuration C1 is thus not shown in FIG. 3.

From FIG. 3 it is clear that the variation in summed intensity is significant, with a FWHM (full width at half maximum) of 3˜4. This proves that the proposed method according to the present invention is indeed capable of determining where in the data page the 2*4 subarrays are located and which is the correct alignment.

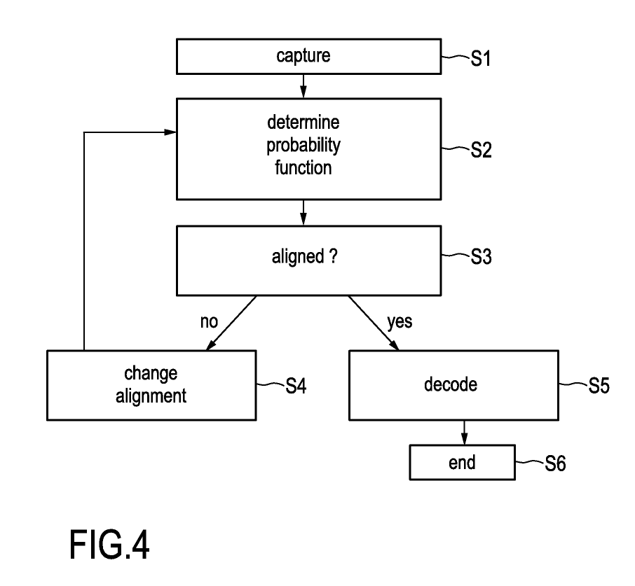

A flowchart illustrating the main steps of the general idea of the present invention is shown in FIG. 4. After capturing an image (step S1) as described above in the usual manner an iterative procedure starts in which the correct alignment of the subarrays in the captured image is determined.

In a first run of said iteration a first alignment of the blocks is assumed, i.e. one of all possible configurations (e.g. for the exemplary 6:8 code one of the eight different configurations C1 to C8 shown in FIG. 2) is selected, and it is determined whether or not said alignment is correct. Hence, in a first step S2 of said iteration the probability function is determined as described above with reference to FIGS. 2 and 3 by summing the intensities for 2*4 blocks for a plurality of blocks, in particular for a substantial part of the image, in order to have sufficient statistics. In other words, for a plurality of blocks of the captured image, which are assumingly aligned according to the configuration selected in said iteration, the number of zeros and ones in each block and for each block the sum is formed. As this is done for a plurality of blocks a probability function as shown in FIG. 3 can be obtained since in misaligned situations the sum can be different in different blocks.

In the next step S3 of the iteration, a parameter, preferably the width, of the probability function obtained in said iteration is determined, and based thereon it is decided whether the parameter fulfills a predetermined condition or not, e.g. if the width is smaller than a predetermined width or not. This basically corresponds with the determination whether the probability function only contains one single peak at the summed value four which would indicate the correct alignment, or whether there is no such single peak but a curve of the form as shown in FIG. 3 with distributed probabilities.

Thus, the decision in step S3 can be that the blocks are not aligned whereafter in a next iteration steps S2 and S3 will be carried out. Beforehand, however, in step S4 the assumed alignment will be changed, i.e. another configuration will be selected, for instance by shifting all blocks horizontally and/or vertically by one pixel. If, on the other hand, the decision in step S3 gives the result that the assumed alignment is correct, in the next step S5 the block modulated data from the captured image are decoded based on the determined alignment of the blocks, i.e. the zeros and ones are determined using preferably a standard sorting algorithm. Thereafter, the read-out of the data page is basically finished (step S6).

The iteration is preferably continued until the correct alignment has been found. Alternatively, instead of using an iteration, it is also possible to determine the probability functions for all possible configurations and then search for the probability function that best indicates the alignment.

Preferably, the optical holographic device of the present invention fulfills the following (not mandatory) conditions, which enable an easier and faster read-out of the data page using the method of the present invention. Preferably, each pixel on the SLM 103 corresponds exactly to one pixel on the detector array 114:
Scaling: pixels of the SLM and the detector array have the same size.
Rotation: the pixel rows/columns of the SLM and the detector are aligned parallel.
Translation: the center of the pixels of the SLM and detector array coincide.

In the above, an embodiment of the present has been discussed in terms of a balanced block modulation code, in particular a 6:8 code. It is, however, evident, that the invention can be equally applied for any other balanced block modulation codes.

Even further, the invention can also be applied for unbalanced block modulation codes. For an unbalanced block modulation code the distribution as shown in FIG. 3 will be distorted, i.e. the peak position shifts and the distribution (probability) function has an asymmetric profile.

In general, it is also possible, to store m-ary symbols in a data page rather than binary bits, but detection will then be more difficult than in a binary system. Hence, the terms “bit” as used in the present application shall not be limited to the meaning “binary bit” having only two different values, but shall be construed as meaning “m-ary symbol” being able to having more than two different, distinguishable values. In brief, in a binary system the pixel intensities are distributed in two peaks (for aligned blocks): one peak around a certain low intensity level and the other peak around a higher intensity level. If these two peaks are clearly separated (no pixels with intermediate intensity levels), a slicer level can be set and all the pixels with intensities below this level are detected (or interpreted) as “zeroes” and all the pixels with intensities above this level are detected (or interpreted) as “ones”. In an m-ary system the pixel intensities are distributed in more than two peaks. Fulfilling the need, that all peak distributions are sufficiently separated, becomes more difficult and consequently the settings for the slicer levels.

Generally, the method for determining the alignment according to the present invention is applied for each detected imaged data page separately. However, if the optical alignment of the system between the read-out of two data pages is stable enough to start reading the second data page at the same position as a first data page, it could be sufficient to carry out the alignment method only once for two or even a couple of data pages.

In the above an embodiment of the present invention has been explained with reference to the figures where the distribution of the summed intensity has been used to determine whether or not the blocks are aligned. However, generally any significance value of function can be used for this purpose as long as it enables the detection whether the code constraint applied in the block modulation code for modulating the data recorded in the data pages is fulfilled or not.

It is also not mandatory to determine the width of the determined probability function, but other features of the probability function could be evaluated as well to get more information, such as, for instance, the level of the highest peak, skewness, kurtosis or other higher order momenta of a (probability) distribution.

While the invention has been illustrated and described in detail in the drawings and foregoing description, such illustration and description are to be considered illustrative or exemplary and not restrictive; the invention is not limited to the disclosed embodiments. Generally, the idea underlying the present invention cannot only applied in holographic data storage systems but also in other fields where image processing requires flat fielding and dark current correction.

Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality. A single unit may fulfill the functions of several items recited in the claims. The mere fact that certain measures are recited in mutually different dependent claims does not indicate that a combination of these measured cannot be used to advantage.

A computer program may be stored/distributed on a suitable medium, such as an optical storage medium or a solid-state medium supplied together with or as part of other hardware, but may also be distributed in other forms, such as via the Internet or other wired or wireless telecommunication systems.

Any reference signs in the claims should not be construed as limiting the scope.

1. Optical holographic device for reading out a data page recorded in a holographic recording medium (106) and carrying data modulated using a block modulation code, according to which a data page is divided into a number of blocks and a code constraint is applied defining the number of data symbols in a block having a predetermined symbol value, said device comprising:
image forming means (104, 105) for forming an imaged data page,
image detection means (114) for detecting said imaged data page,
alignment means (115) for determining the alignment of the blocks in said detected imaged data page by iteratively determining, for a different alignment of the blocks in each iteration, whether for said alignments said code constraint is fulfilled or not, and
decoding means (116) for decoding the block modulated data from said detected imaged data page based on the determined alignment of the blocks.

2. Optical holographic device as claimed in claim 1, wherein said modulation code is a balanced modulation code, according to which a code constraint is applied defining that the number of data symbols in a block having a first symbol value, in particular bit value zero, is identical to the number of data symbols in the same block having a second symbol value, in particular bit value one.

3. Optical holographic device as claimed in claim 1, wherein said modulation code is an unbalanced modulation code, according to which a code constraint is applied defining that the number of data symbols in a block having a first symbol value, in particular bit value zero, is different from the number of data symbols in the same block having a second symbol value, in particular bit value one, wherein said numbers are identical for all blocks and known to the alignment means.

4. Optical holographic device as claimed in claim 1, wherein said alignment means (115) are adapted for determining, in each iteration, a significance value or function based on the symbol values per block and based on a number of blocks of said determined imaged data page and for determining, whether, for the alignment of the blocks applied in said iteration, said code constraint is fulfilled or not based on said significance value or function.

5. Optical holographic device as claimed in claim 4, wherein said alignment means (115) are adapted for determining, in each iteration, the sum of the symbol values and/or the summed intensity values for said number of blocks as said significance value or function.

6. Optical holographic device as claimed in claim 4, wherein said alignment means (115) are adapted for determining, in each iteration, a probability function indicating the probability to find a summed symbol or intensity value in a block and for determining, whether, for the alignment of the blocks applied in said iteration, said code constraint is fulfilled or not based on said probability function.

7. Optical holographic device as claimed in claim 6, wherein said alignment means (115) are adapted for determining the width of said probability function and for checking whether said width is smaller than a predetermined width.

8. Electronic device (117) for use in an optical holographic device as defined in claim 1 for reading out a data page recorded in a holographic recording medium (106) and carrying data modulated using a block modulation code, according to which a data page is divided into a number of blocks and a code constraint is applied defining the number of data symbols in a block having a predetermined symbol value, wherein said optical holographic device comprises an image forming means (104, 105) for forming an imaged data page and an image detection means (114) for detecting said imaged data page, said electronic device comprising:
alignment means (115) for determining the alignment of the blocks in said detected imaged data page by iteratively determining, for a different alignment of the blocks in each iteration, whether for said alignments said code constraint is fulfilled or not, and
decoding means (116) for decoding the block modulated data from said detected imaged data page based on the determined alignment of the blocks.

9. Method for reading out a data page recorded in a holographic recording medium (106) and carrying data modulated using a block modulation code, according to which a data page is divided into a number of blocks and a code constraint is applied defining the number of data symbols in a block having a predetermined symbol value, said method comprising the steps of:
forming an imaged data page,
detecting said imaged data page,
determining the alignment of the blocks in said detected imaged data page by iteratively determining, for a different alignment of the blocks in each iteration, whether for said alignments said code constraint is fulfilled or not, and
decoding the block modulated data from said detected imaged data page based on the determined alignment of the blocks.

10. Method for use in an optical holographic device as defined in claim 1 for reading out a data page recorded in a holographic recording medium (106) and carrying data modulated using a block modulation code, according to which a data page is divided into a number of blocks and a code constraint is applied defining the number of data symbols in a block having a predetermined symbol value, wherein said optical holographic device comprises an image forming means for forming an imaged data page and an image detection means for detecting said imaged data page, said method comprising the steps of:
determining the alignment of the blocks in said detected imaged data page by iteratively determining, for a different alignment of the blocks in each iteration, whether for said alignments said code constraint is fulfilled or not, and
decoding the block modulated data from said detected imaged data page based on the determined alignment of the blocks.

11. Computer program comprising program code means for causing a computer to carry out the steps of the method as claimed in claim 9, when said computer program is carried out on a computer.
